(19) United States
(12) Patent Application Publication
(10) Pub. No.: US 2014/0240872 A1
(43) Pub. Date: Aug. 28, 2014

(54) POWER-SUPPLY UNIT

(71) Applicant: Atsushi NOMURA, Toyota-shi (JP)

(72) Inventor: Atsushi NOMURA, Toyota-shi (JP)

(73) Assignee: TOYOTA JIDOSHA KABUSHIKI KAISHA, Toyota-shi (JP)

(21) Appl. No.: 14/173,197

(22) Filed: Feb. 5, 2014

(30) Foreign Application Priority Data
Feb. 25, 2013 (JP) 2013-034630

(51) Int. Cl. H02H 3/08

(52) U.S. Cl. CPC H02H 3/08
USPC 361/18

(57) ABSTRACT

A power-supply unit includes a high-voltage source that generates a high voltage between a positive electrode and a negative electrode, a smoothing capacitor connected between the positive electrode and the negative electrode, a discharge portion that includes a resistor and a first switching device connected in series with each other, and is connected between the positive electrode and the negative electrode, and a discharge control portion that controls the first switching device to one of an ON state and an OFF state. When an abnormal condition in which current flows through the resistor is detected while the discharge portion controls the first switching device so as to keep the first switching device in the OFF state, the high-voltage source is controlled so as to keep generating a given high voltage for fusing the resistor.

### INCORPORATION BY REFERENCE

The disclosure of Japanese Patent Application No. 2013-034630 filed on Feb. 25, 2013 including the specification, drawings and abstract is incorporated herein by reference in its entirety.

### BACKGROUND OF THE INVENTION

1. Field of the Invention

The invention relates to a power-supply unit for supplying electric power to a load unit, such as a motor for driving a vehicle, and a motor for driving a machine, for example.

2. Description of Related Art

Generally, a power-supply unit for supplying electric power to a load unit, such as a driving motor, often includes a switching circuit, such as an inverter. Accordingly, the power-supply unit of this type often includes a smoothing capacitor. Since the smoothing capacitor is connected between a positive electrode and a negative electrode of the power-supply unit, the voltage between the opposite ends of the capacitor is relatively high. Thus, a large quantity of electric charge is stored in the smoothing capacitor. Therefore, when an abnormality occurs to the vehicle, machine, or the like, it is desired to quickly discharge the smoothing capacitor (quickly release the electric charge stored in the smoothing capacitor).

In one example of the related art concerning the power-supply unit for the vehicle, a discharge portion (rapid discharge circuit) including a resistor (resistive element) and a switching device (transistor) is arranged in parallel with the smoothing capacitor, and the switching device is switched to an ON state when a collision of the vehicle is detected. As a result, the smoothing capacitor is rapidly discharged after detection of the vehicle collision (see, for example, Japanese Patent Application Publication No. 2012-186887 (JP 2012-186887 A).

However, if the switching device of the discharge portion is brought into a condition of a short-circuit fault, for example, the voltage between the positive electrode and the negative electrode is reduced; therefore, sufficient electric power cannot be supplied to the load unit. Accordingly, where the load unit is a motor for driving a vehicle or a machine, the vehicle or machine may not continue to be normally operated.

### SUMMARY OF THE INVENTION

The invention provides a power-supply unit that is able to continue to supply electric power to a load unit, by cutting off a discharge current pathway formed by a discharge portion, when an abnormal condition in which a smoothing capacitor is discharged via the discharge portion in a situation where the smoothing capacitor should not be discharged is detected.

A aspect of the invention is concerned with a power-supply unit including a high-voltage source configured to generate a high voltage between a positive electrode and a negative electrode so as to supply electric power to a load unit connected to the positive electrode and the negative electrode, a smoothing capacitor connected to the positive electrode and the negative electrode, a discharge portion that includes a resistor and a first switching device connected in series with each other, and is connected to the positive electrode and the negative electrode, a discharge control portion configured to control the first switching device to one of an ON state and an OFF state, and an abnormality detecting portion configured to detect occurrence of an abnormal condition in which electric current flows through the resistor even though the discharge control portion controls the first switching device so as to keep the first switching device in the OFF state. The smoothing capacitor and the discharge portion are configured such that an electric charge of the smoothing capacitor is discharged by the discharge portion when the first switching device is in the ON state.

Furthermore, the power-supply unit according to the aspect of the invention includes a forcedly cutting-off portion configured to forcedly cut off a discharge current pathway formed by the discharge portion, when the abnormal condition is detected.

With the above arrangement, when the above-described abnormal condition is detected, the forcedly cutting-off portion forcedly cuts off the discharge current pathway; therefore, the voltage between the terminals of the smoothing capacitor is not reduced, and electric power can be kept supplied to the load unit.

Accordingly, when the power-supply unit is used as a device for supplying electric power to a motor for driving a vehicle as a load unit, it is possible to keep the vehicle running.

When the abnormal condition is detected, the forcedly cutting-off portion may be configured to control the high-voltage source so that the high-voltage source keeps generating a given high voltage for fusing the resistor of the discharge portion.

With the above arrangement, when the above-described abnormal condition is detected, the resistor of the discharge portion fuses due to heat generated by the resistor, so that the discharge current pathway is cut off; therefore, the voltage between the terminals of the smoothing capacitor is not reduced, and electric power can continue to be supplied to the load unit.

The discharge portion may include a second switching device connected in series with the resistor and the first switching device, and the forcedly cutting-off portion may be configured to switch the second switching device from an ON state to an OFF state when the abnormal condition is detected.

With the above arrangement, when the above-described abnormal condition is detected, the second switching device is placed in the OFF state; therefore, the voltage between the terminals of the smoothing capacitor is not reduced, and electric power can continue to be supplied to the load unit.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view showing the configuration of a power-supply unit, load unit, and a drive unit of a vehicle according to a first embodiment of the invention;

FIG. 2 is a flowchart illustrating a routine executed when a CPU of an integrated control device shown in FIG I performs a forcedly cutting-off operation;

FIG. 3 is a view useful for explaining a method of designing a discharge resistor shown in FIG. 1;

FIG. 4 is a schematic view showing the configuration of a power-supply unit, load unit, and a drive unit of a vehicle according to a second embodiment of the invention; and

FIG. 5 is a flowchart illustrating a routine executed when a CPU of an integrated control device shown in FIG. 4 performs a forcedly cutting-off operation.

### DETAILED DESCRIPTION OF EMBODIMENTS

A power-supply unit according to each embodiment of the invention will be described with reference to the drawings. The power-supply unit of each embodiment is applied to a hybrid vehicle. It is, however, to be understood that the invention may also be applied to vehicles, such as an electric vehicle and a fuel-cell vehicle, and systems, such as machine tools, ships and aircraft, including a load unit (e.g., a motor) using electric power supplied from a high-voltage power supply.

### First Embodiment

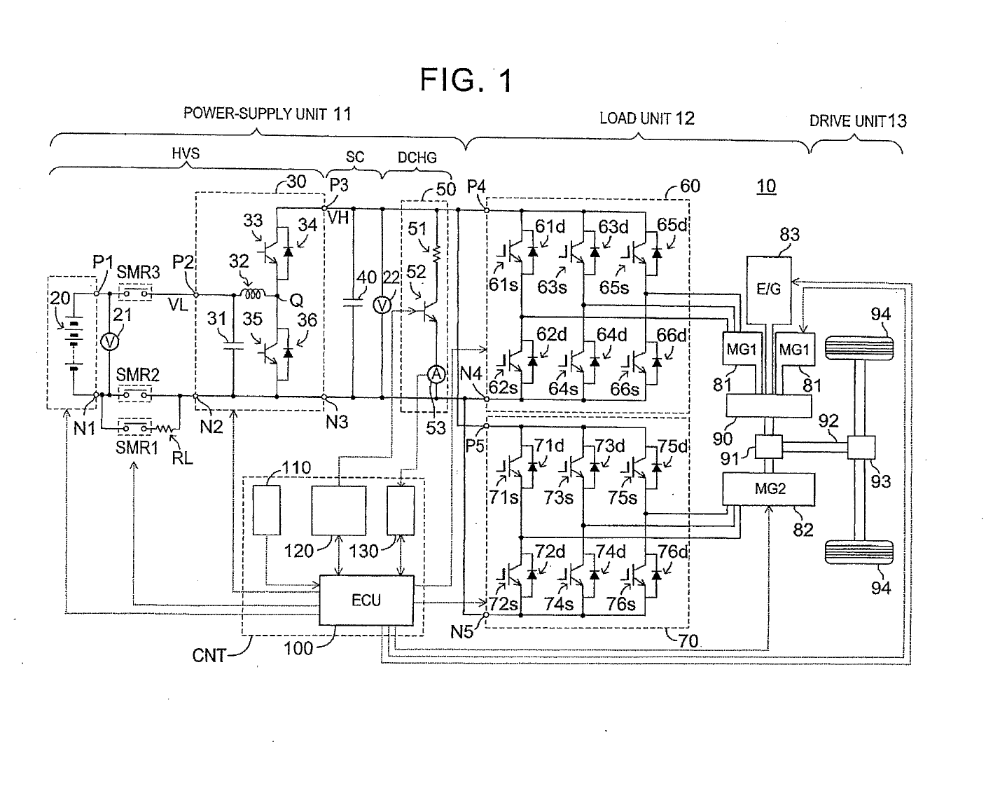

(Configuration) As shown in FIG. 1, a power-supply unit (which will also be called “first power-supply unit”) 11 according to a first embodiment of the invention is installed on a hybrid vehicle (which will also be called “vehicle”) 10. Further, a load unit 12 and a drive unit 13 are installed on the vehicle 10.

The power-supply unit 11 includes a high-voltage source HVS, a smoothing capacitor portion SC, and a discharge portion DCHG.

The high-voltage source HVS includes a storage battery 20, a boost converter 30, and system main relays SMR1-SMR3.

The storage battery 20 is a chargeable/dischargeable secondary battery, which is a lithium-ion battery in this embodiment. The storage battery 20 generates DC power to a pair of storage-battery terminals P1, N1. The storage battery 20 is charged with voltage applied from the outside to the pair of storage-battery terminals P1, N1.

The boost converter 30 has a pair of low-voltage-side terminals P2, N2, and a pair of high-voltage-side terminals P3, N3. The boost converter 30 includes a capacitor 31, reactor 32, first transistor (power MOSFET) 33, diode 34, second transistor (power MOSFET) 35, and a diode 36. These elements constitute a known boost chopper circuit as shown in FIG. 1.

By using the boost chopper circuit, the boost converter 30 can convert “a low-voltage-side voltage VL substantially equal to a voltage (i.e., storage-battery voltage) between the pair of storage-battery terminals P1, N1” into “a high-voltage-side voltage VH as a voltage between the pair of high-voltage-side terminals P3, N3)”, and vice versa. Namely, the first transistor 33 and the second transistor 35 are switched based on a PWM (Pulse Width Modulation) signal from an integrated control device 100 (which will be described later), so that the boost converter 30 can perform a boosting or step-up operation to convert the low-voltage-side voltage VL to the high-voltage-side voltage VH, and a step-down operation to convert the high-voltage-side voltage VH to the low-voltage-side voltage VL. The operation of the boost converter 30 is well known, and therefore will not be further described.

The system main relays (which will be called “relays) SMR1-SMR3 are devices that operate in conjunction with “a power switch of the vehicle 10” (not shown) to connect and disconnect the storage battery 20 to and from the boost converter 30. The relay SMR1 is connected between the terminal N1 and one end of a resistor RL. The other end of the resistor RL is connected to the terminal N2. The relay SMR2 is connected between the terminal Ni and the terminal N2. The relay SMR3 is connected between the terminal P1 and the terminal P2. The relays SMR1-SMR3 are opened and closed according to a signal from the integrated control device 100.

The smoothing capacitor portion SC includes a smoothing capacitor 40. The smoothing capacitor 40 is connected between the terminal P3 and the terminal N3, and smoothens ripples generated between the terminal P3 and the terminal N3.

The discharge portion DCHG includes a rapid discharge circuit 50. The rapid discharge circuit 50 is connected in parallel with the smoothing capacitor 40. Namely, the rapid discharge circuit 50 is connected between the terminal P3 and the terminal N3. The rapid discharge circuit 50 includes a discharge resistor 51, switching device 52, and a discharge current sensor 53. The discharge resistor 51, switching device 52, and the discharge current sensor 53 are connected in series. In this embodiment, the discharge current sensor 53 is a shunt resistor. The switching device 52 is also called “first switching device” for the sake of convenience. The switching device 52 is a power MOSFET.

The load unit 12 includes a first inverter 60, second inverter 70, first motor 81, and a second motor 82.

The first inverter 60 has a pair of input terminals P4, N4. The pair of input terminals P4, N4 are respectively connected to the pair of high-voltage-side terminals P3, N3 of the boost converter 30. The first inverter 60 includes a U-phase arm, V-phase arm, and a W-phase arm. Each of these arms is inserted between the pair of input terminals P4, N4, and these arms are connected in parallel with each other.

The U-phase arm of the first inverter 60 has an IGBT 61s and an IGBT 62s. A diode 61d and a diode 62d are connected in inverse parallel with the IGBT 61s and the IGBT 62s, respectively. The IGBT 61 s and the IGBT 62s are connected in series with each other. A point of connection between the IGBT 61s and the IGBT 62s is connected to a U-phase coil (not shown) of the first motor 81.

The V-phase arm of the first inverter 60 has an IGBT 63s, diode 63d, IGBT 64s, and a diode 64d. The relationship of connection among these elements is identical with that of the U-phase arm, as shown in FIG. 1, and a point of connection between the IGBT 63s and the IGBT 64s is connected to a V-phase coil (not shown) of the first motor 81.

The W-phase arm of the first inverter 60 has an IGBT 65s, diode 65d, IGBT 66s, and a diode 661 The relationship of connection among these elements is identical with that of the U-phase arm, as shown in FIG. 1, and a point of connection between the IGBT 65s and the IGBT 66s is connected to a W-phase coil (not shown) of the first motor 81.

By using these devices, the first inverter 60 converts DC power received from the boost converter 30 into three-phase AC power of the U phase, V phase and W . phase, and delivers the AC power to the first motor 81, according to a signal from the integrated control device 100. The operation of the first inverter 60 is well known, and therefore, will not be further described.

The second inverter 70 is configured similarly to the first inverter 60. Namely, a pair of input terminals P5, N5 of the second inverter 70 are connected to the pair of high-voltage-side terminals P3, N3 of the boost converter 30, respectively. The second inverter 70 includes IGBTs 71s-76s and diodes 71d-76d. By using these devices, the second inverter 70 converts DC power received from the boost converter 30 into three-phase AC power of the U phase, V phase and W phase, and delivers the AC power to the second motor 82, according to a signal from the integrated control device 100. The operation of the second inverter 70 is well known, and therefore, will not be further described.

The first motor 81 and the second motor 82 are synchronous generator-motors. Namely, each of the first motor 81 and the second motor 82 may operate as an electric motor and also operate as a generator. The first motor 81 is mainly used as a generator. The second motor 82 is mainly used as an electric motor, and generates driving force of the vehicle 10 (torque for running the vehicle 10).

The drive unit 13 includes an internal combustion engine 83, power split device 90, speed reducing device 91, drive shaft 92, differential gear 93, and drive wheels 94.

The internal combustion engine 83 is a gasoline engine, and is able to generate driving force of the vehicle 10. The intake air amount, fuel injection amount, etc. of the internal combustion engine 83 are controlled based on signals from the integrated control device 100.

The power split device 90 includes a planetary gear mechanism, and is arranged to convert torque from the internal combustion engine 83, first motor 81 and second motor 82, and deliver the torque to the differential gear 93 via the speed reducing device 91 and the drive shaft 92. The torque delivered to the differential gear 93 is transmitted to the drive wheels 94. The power split device 90 and its control method are well known, and are described in detail .in, for example, Japanese Patent Application Publication No. 2009-126450 (JP 2009-126450 A) (U.S. Patent Application Publication No. 2010/0241297), and Japanese Patent Application Publication No. 9-308012 (JP 9-308012 A) (U.S. Pat. No. 6,131,680 having a U.S. filing date of Mar. 10, 1997). These publications are referred to herein, and thus incorporated into the specification of this application.

The vehicle 10 further includes a control unit CNT. The control unit CNT includes an integrated control device 100, collision detecting portion 110, rapid discharge control circuit 120, and an abnormality detecting portion 130.

The integrated control device 100 includes a plurality of electronic control units (ECUs) for controlling the vehicle 10. Namely, the integrated control device 100 includes a power management ECU that performs integrated control of the driving force of the vehicle 10, battery charge, and so forth, MG-ECU that controls the first motor 81 and the second motor 82, engine-ECU that controls the internal combustion engine 83, battery-ECU that monitors the storage battery 20, and so forth. Each of the electronic control units is a microcomputer that includes a CPU, memory, etc., and executes corresponding programs. The electronic control units exchange information with each other via communication lines.

The integrated control device 100 is connected to the storage battery 20, relays SMR1-SMR3, boost converter 30, first inverter 60, second inverter 70, collision detecting 110, rapid discharge control circuit 120, and the abnormality detecting portion 130. The integrated control device 100 is configured to send a “discharge command signal” to the rapid discharge control circuit 120, when it receives a collision detection signal from the collision detecting portion 110. Further, the integrated control device 100 is configured to send a “resistor fusing high-voltage generation command signal” to the boost converter 30, based on a signal from the abnormality detecting portion 130, when a short-circuit fault as described later occurs.

The collision detecting portion 110 determines whether a collision of the vehicle 10 has occurred by a well-known method, based on a signal from a G sensor (acceleration sensor) installed at an appropriate location in the vehicle 10. When it is determined that a collision of the vehicle 10 has occurred, the collision detecting portion 110 sends a collision detection signal to the integrated control device 100.

When the rapid discharge control circuit 120 receives the discharge command signal from the integrated control device 100, it switches the switching device 52 from a cut-off state (OFF) to an energized state (ON), so as to discharge the smoothing capacitor 40,

The abnormality detecting portion 130 receives a voltage across the opposite ends of the discharge current sensor 53. Since the discharge current sensor 53 is a shunt resistor, the voltage across its opposite ends is proportional to current that flows through “a discharge current pathway consisting of the discharge resistor 51 and the switching device 52”. The abnormality detecting portion 130 compares the voltage received from the discharge current sensor 53 with a threshold value used for determining a short-circuit fault (abnormal condition), and sends the result of comparison to the integrated control device 100.

The discharge resistor 51 is provided for discharging an electric charge stored in the smoothing capacitor 40 and reducing the voltage of the smoothing capacitor 40 to a given voltage or lower (e.g., 60V or lower) within a given period of time (5 sec. or shorter), when a collision of the vehicle 10 is detected by the collision detecting portion 110. On the other hand, during normal running of the vehicle 10, the rapid discharge control circuit 120 controls the switching device 52 so that the switching device 52 is kept in the “OFF” state.

When an abnormal condition (an abnormal condition where current flows through the discharge resistor 51 and the switching device 52) in which the switching device 52 is placed in the “ON” state for some reason is detected, even though the switching device 52 is controlled by the rapid discharge control circuit 120 so as to be placed in the “OFF” state, the boost converter 30 is controlled so that the voltage across the pair of high-voltage-side terminals P3, N3 is raised to a forcedly boosted voltage, based on the above-mentioned “resistor fusing high-voltage generation command signal”. As a result, large current is caused to flow through the discharge resistor 51, and the discharge resistor 51 is designed to be fused or melted down due to the current flowing therethrough. A method of designing the discharge resistor 51 of this type will be described later.

Further, the vehicle 10 includes a voltmeter 21 and a voltmeter 22. The voltmeter 21 measures the low-voltage-side voltage VL, and sends it to the integrated control device 100. The voltmeter 22 measures the high-voltage-side voltage VH, and sends it to the integrated control device 100.

The integrated control device 100 determines a target value of the high-voltage-side voltage VH based on the torque required of the vehicle 10, and controls the boost converter 30 so that the actual high-voltage-side voltage VH detected by the voltmeter 22 coincides with the target value. During running (normal running) of the vehicle 10, the target value of the high-voltage-side voltage VH is kept at a voltage (e.g., 200-400V) that is lower than the forcedly boosted voltage (e.g., 600V) as will be described later. However, the target value of the high-voltage-side voltage VH during normal running may be momentarily set to a voltage equivalent to the forcedly boosted voltage.

(Operation) Next, the operation of the first power-supply unit 11 constructed as described above will be described with regard to the case of a collision of the vehicle 10, and the case of a short-circuit fault, respectively.

<Case of Collision> As described above, when the vehicle 10 comes into collision, a collision detection signal is transmitted from the collision detecting portion 110 to the integrated control device 100. In response to the signal, the integrated control device 100 sends a “discharge command signal” to the rapid discharge control circuit 120. The rapid discharge control circuit 120, which has received this signal, performs control so as to bring the first switching device 52 of the rapid discharge circuit 50 into the ON state. Accordingly, electric current flows through the discharge resistor 51 of the rapid discharge circuit 50, and an electric charge stored in the smoothing capacitor 40 is discharged.

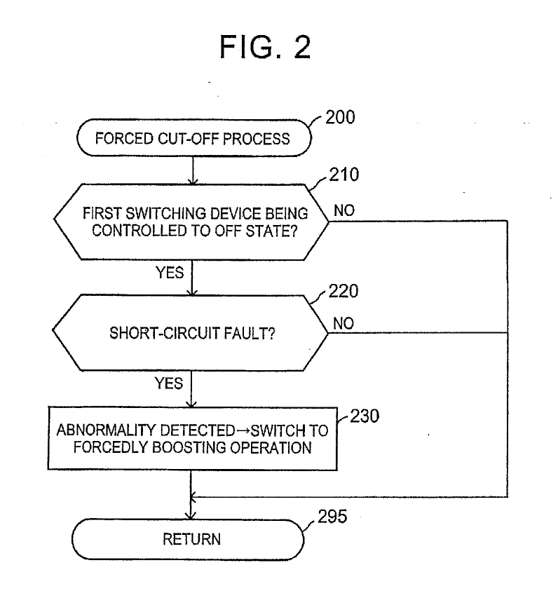

At the same time, the integrated control device 100 sends an “open command signal” to the relays SMR1-SMR3, so as to immediately stop the operation of a high-voltage system of the power-supply unit 11. As a result, the relays SMR1-SMR3 are immediately opened, and supply of electric power via the boost converter 30 is stopped. Accordingly, in the event of the collision of the vehicle 10, the electric charge stored in the smoothing capacitor 40 is rapidly discharged.

<Case of Short-circuit Fault> As described above, when a short-circuit fault (abnormal condition, abnormal discharge condition) takes place, the integrated control device 100 sends a “resistor fusing high-voltage generation command signal” to the boost converter 30, based on a signal from the abnormality detecting portion 130. This point will be described in more detail with reference to the flowchart of FIG. 2.

The CPU of the integrated control device 100 is configured to execute a routine as illustrated in the flowchart of FIG. 2 each time a given length of time elapses. Thus, at an appropriate time, the CPU starts the routine from step S200, and proceeds to step S210 to determine whether the CPU sends an “OFF” command to the first switching device 52 of the rapid discharge circuit 50. In other words, the CPU determines whether “no discharge command signal is generated” at this point in time.

If the vehicle 10 is in a collision as described above, the CPU sends a command signal for placing the first switching device 52 in the ON state to the rapid discharge control circuit 120. Namely, the CPU generates a discharge command signal. In this case, the CPU makes a negative (“NO”) decision in step S210, and directly proceeds to step S295 to once finish the routine.

If the vehicle 10 is not in a collision but in a normal running condition, the CPU sends a signal for controlling the first switching device 52 to the OFF state, to the rapid discharge control circuit 120. In this case, the CPU makes an affirmative decision (“YES”) in step S210, and proceeds to step S220 to determine whether the result of comparison transmitted from the abnormality detecting portion 130 indicates “occurrence of a short-circuit fault (abnormal condition)”.

The “short-circuit fault (abnormal condition)” may occur for some reasons. For example, two reasons as follows may be considered.

(1) The interior of the first switching device 52 is in a constantly short-circuited condition due to insulation breakdown of the first switching device 52.

(2) The rapid discharge control circuit 120 fails, and a signal for setting the first switching device 52 to the ON state is sent from the rapid discharge control circuit 120 to the first switching device 52, even though a “command for setting the first switching device 52 to the OFF state” is sent from the integrated control device 100 (CPU) to the rapid discharge control circuit 120.

Suppose that a short-circuit fault occurs. In this case, the voltage across the opposite ends of the discharge current sensor (shunt resistor) 53 becomes larger than a threshold value for determining short-circuit fault. Accordingly, the abnormality detecting portion 130 sends a signal indicative of this fact (occurrence of the short-circuit fault), to the integrated control device 100. As a result, the CPU makes an affirmative decision (“YES”) in step S220, and proceeds to step S230 to send the above-described “resistor fusing high-voltage generation command signal” to the boost converter 30.

Namely, when the CPU proceeds to step S230, it sets the target value VHtgt of the voltage VH between the output terminals of the boost converter 30 (voltage between the pair of high-voltage-side terminals P3, N3), to the “forcedly boosted voltage (e.g., 600V)”, irrespective of a load condition of the load unit 12. Further, the CPU controls the boost converter 30 so that the voltage VH between the output terminals of the boost converter 30 coincides with the target value VHtgt. As a result, the voltage between the pair of high-voltage-side terminals P3, N3 is forcedly raised to the forcedly boosted voltage. This operation of the CPU will also be called “forced boosting operation”.

At this time, since the first switching device 52 remains in the “ON” state, current I (=VHtgt/RD) substantially flows through the discharge resistor 51 where RD is a resistance value of the discharge resistor 51. It is to be noted that the resistance of the first switching device 52 when it is in the “ON” state and the resistance of the discharge current sensor 53 are sufficiently smaller than the value RD, and thus can be neglected.

In the meantime, the rating of the discharge resistor 51 is designed so that the discharge resistor 51 fuses without fail if the “forced boosting operation” lasts for a given period of time. As a result, the discharge resistor 51 fuses, and the discharge current pathway of the rapid discharge circuit 50 is cut off or disconnected, so that the voltage between the pair of high-pressure-side terminals P3, N3 is maintained. Accordingly, electric power can be kept supplied to the load unit 12 (the first motor 81, second motor 82, etc.), thereby to keep the vehicle 10 running. Then, the CPU proceeds to step S295 to once finish this routine.

After executing the forced boosting operation, the CPU continues to monitor the result of determination from the abnormality detecting portion 130. When the result of determination is “a result indicating fusing of the discharge resistor 51” (namely, when the voltage between the opposite terminals of the discharge current sensor (shunt resistor) 53 becomes smaller than the threshold value for determining short-circuit fault), the CPU may set the target value VHtgt of the voltage VH between the output terminals of the boost converter 30 to “a given value smaller than the forcedly boosted voltage”.

As explained above, the first power-supply unit 11 includes the high-voltage source HVS that generates a high voltage between the positive electrode (terminal P3) and the negative electrode (terminal N3) so as to supply electric power to the load unit 12 connected to the positive electrode and the negative electrode, the smoothing capacitor 40 connected between the positive electrode and the negative electrode, the discharge portion DCHG (rapid discharge circuit 50) that is connected between the positive electrode and the negative electrode and includes the resistor (resistive element) 51 and the first switching device 52 connected in series with each other, and the discharge control portion (discharge control circuit) 120 that controls the first switching device 52 to any one of the “ON” state and the “OFF” state. In the first power-supply unit 11, when the first switching device 52 is in the “ON” state, an electric charge stored in the smoothing capacitor 40 is discharged by means of the discharging portion DCHG (rapid discharge circuit 50). The first power-supply unit 11 further includes a forcedly cutting-off portion (the integrated control device 100, step S210-step S230 of FIG. 2) that controls the high-voltage source HVS so that it continues to generate a given high voltage (forcedly boosted voltage) so as to fuse the resistor 51, when an abnormal condition in which electric current (current equal to or larger than a value corresponding to the threshold value for determining a short-circuit fault (abnormal condition)) flows through the resistor (discharge resistor) 51 is detected while the discharge control circuit 120 controls the first switching device 52 so as to keep the first switching device 52 in the “OFF” state.

Accordingly, when a short-circuit fault occurs to the rapid discharge circuit 50 of the vehicle 10, a current that exceeds the rated current of the discharge resistor 51 is caused to flow through the discharge resistor 51 in the rapid discharge circuit 50, so as to fuse the discharge resistor 51. Namely, the discharge current pathway is forcedly cut off, and discharging is stopped. In other words, the discharge resistor 51 itself has the function of shifting the rapid discharge circuit 50 from the short-circuited condition (abnormal condition) to the forced cut-off condition. Accordingly, the power-supply unit 11 is able to forcedly cut off the discharge current pathway when an abnormal condition is detected, without requiring a new component(s) to be added to the rapid discharge circuit 50. Thus, even in the event of a short-circuit fault, electric power can be supplied to the load unit 12, so as to enable the vehicle 10 to run.

A method of designing the resistance value RD and rating of the discharge resistor 51 that can be fused without fail in the forcedly boosting operation as described above will be described below.

Initially, a normal operation of the rapid discharge circuit 50 at the time of a collision of the vehicle 10 will be considered. If the vehicle 10 comes into collision, and the collision detecting portion 110 operates normally, the integrated control device 100 generates a command to place the relays SMR1-SMR3 in the “OFF” states. Then, the relays SMR1-SMR3 are placed in the “OFF” states, and supply of input voltage to the boost converter 30 is stopped. Further, the integrated control device 100 generates a command to place the first switching device 52 of the rapid discharge circuit 50 in the “ON” state. At this time, an electric charge stored in the smoothing capacitor 40 is discharged. The following are conditions under which the rating of the discharge resistor 51 is designed.
Design Conditions (normal time)

Maximum output value of the boost converter 30: VH=600V

Initial voltage value at the time of discharge: VH=600V (1)

Target voltage value of discharge: VH=60V after 5 sec. (2)

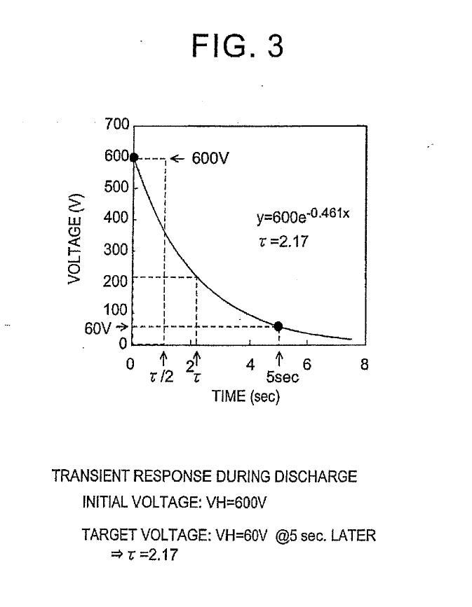

Under the above-indicated conditions (1), (2), the voltage V during discharge is expressed by the following equation, where t (sec.) indicates time (see FIG. 3).

V=600 exp(−0.46 τ)
Accordingly, the time constant T is determined as follows.

τ=1/0.461=2.17 (sec.)

The resistance value RD of the discharge resistor 51 showing the above discharge characteristics is determined as follows, where CS denotes the capacitance value CS of the smoothing capacitor 40.

RD=τ/CS

Then, under the above-indicated conditions, the Joule-integral value I²t during discharge is obtained (electric current during discharge is regarded as being proportional to the voltage VH between the terminals). A general formula for the Joule-integral value I²t is expressed by the following equation, where i (t) indicates current.

I²t=∫i²(t)dt

In the case of charge/discharge waveform that makes an exponential transition, the Joule-integral value I²t₁ is expressed by the following equation (3).

I²t₁=(½)·(VH/RD)²·τ (3)

While the I²t value of the actual discharge resistor 51 is selected based on the value of the above equation (3) in view of the temperature derating, or the like, the one of the minimum rating is normally selected, in the light of the component cost and component size.

Then, suppose that the output voltage VH of the boost converter 30 is forcedly fixed to 600V. The discharge waveform in this case may be considered as a rectangular waveform. In the case of rectangular waveform, the Joule-integral value is expressed by the following equation (4), where t (sec.) indicates time.

I²t₂=(VH/RD)²·t (4)

The time t when the Joule-integral value of the above equation (4) coincides with the integral value of the above equation (3) is expressed as follows.

t=τ/2

Accordingly, where the voltage is a constant value of 600V, the resistor fuses when the time (t) starts being longer than τ/2. It is, however, to be understood that the above-described derating is not taken into consideration, for the sake of simplicity.

If the discharge resistor 51 designed as described above is used in the rapid discharge circuit 50, the Joule-integral value of the discharge resistor 51 exceeds the rated value upon a lapse of about (τ/2) sec. after start of the forced boosting operation in which VH is fixed to 600V, and the discharge resistor 51 fuses.

### Second Embodiment

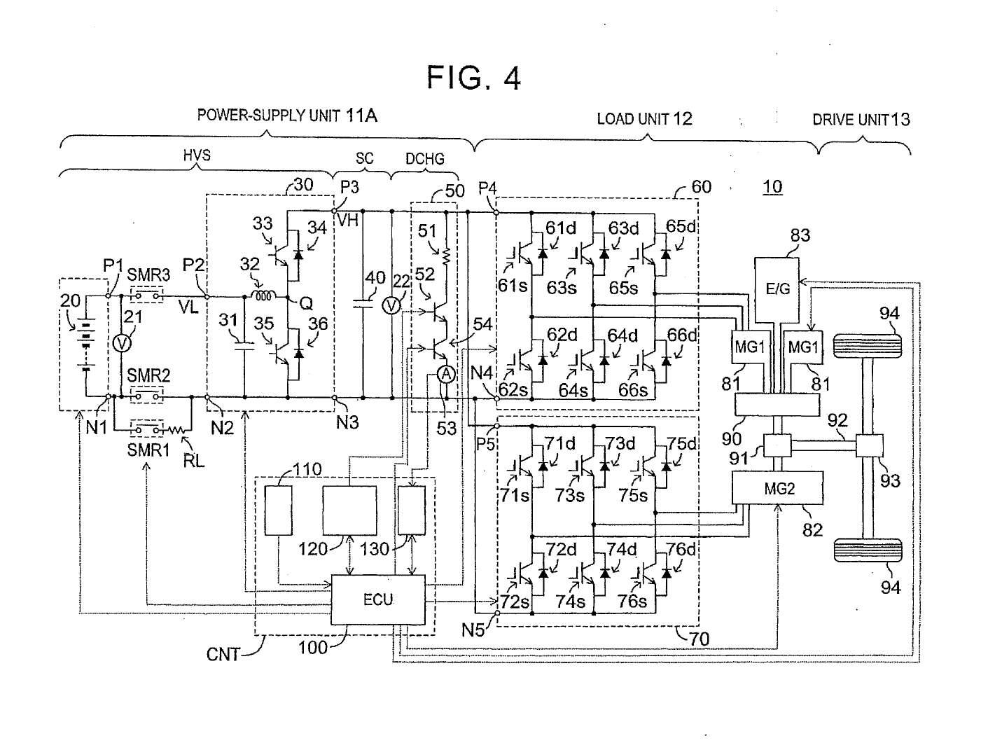

(Configuration) Next, a power-supply unit 11A (which will also be called “second power-supply unit”) according to a second embodiment of the invention will be described. As shown in FIG. 4, the second power-supply unit 11A is applied to the hybrid vehicle 10, like the first power-supply unit 11. In the following description, the same reference numerals as used in the description of the first embodiment are assigned to the same or corresponding constituent elements or steps as those of the first embodiment.

The second power-supply unit 11A is different from the first power-supply unit 11, only in that a second switching device 54 is provided in the discharge portion DCHG, and that, in the event of a short-circuit fault, the second switching device 54 is switched from an “ON” state to an “OFF” state, instead of execution of the forcedly boosting operation during a short-circuit fault. In the following, these differences will be mainly described.

The second switching device 54 is connected in series with the discharge resistor 51 and the first switching device 52. The second switching device 54 is a power MOSFET, like the first switching device 52. The second switching device 54 is adapted to change from the “ON” state to the “OFF” state, based on a “cut-off command signal” from the integrated control device 100.

When the integrated control device 100 receives a collision detection signal from the collision detecting portion 110, it sends a “discharge command signal” to the rapid discharge control circuit 120. Further, the integrated control device 100 controls the second switching device 54 to the “ON” state while the vehicle 10 is running. However, when the above-described short-circuit fault occurs, the integrated control device 100 is configured to send the “cut-off command signal” to the second switching device 54, based on a signal from the abnormality detecting portion 130,

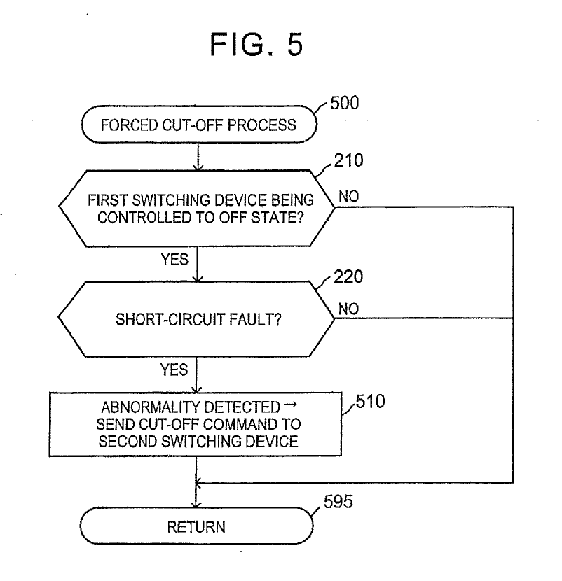

(Operation) Next, the operation of the second power-supply unit 11A constructed as described above will be described. At the time of a collision of the vehicle 10, the second power-supply unit 11A operates in the same manner as the first power-supply unit 11 as described above. In the following, the case where a short-circuit fault occurs will be described.

<Case of Short-circuit Fault> As described above, when the short-circuit fault as described above occurs, the integrated control device 100 sends the “cut-off command signal” to the second switching device 54, based on the signal from the abnormality detecting portion 130. This point will be described in more detail with reference to the flowchart of FIG. 5.

The CPU of the integrated control device 100 executes a routine illustrated in the flowchart of FIG. 5 each time a given length of time elapses. Thus, at an appropriate time, the CPU starts the routine from step S500 of FIG. 5, and proceeds to step S210 to determine whether the CPU sends an “OFF” command to the first switching device 52 of the rapid discharge circuit 50. In other words, the CPU determines whether “no discharge command signal is generated” at this point in time.

If the vehicle 10 is in a collision as described above, the CPU sends a command signal for placing the first switching device 52 in the ON state to the rapid discharge control circuit 120. Namely, the CPU generates a discharge command signal. In this case, the CPU makes a negative decision (“NO”) in step S210, and directly proceeds to step S595 to once finish the routine.

If the vehicle 10 is not in a collision but in a normal running condition, the CPU sends a signal for controlling the first switching device 52 to the OFF state, to the rapid discharge control circuit 120. In this case, the CPU makes an affirmative decision (“YES”) in step S210, and proceeds to step S220 to determine whether the result of comparison transmitted from the abnormality detecting portion 130 indicates “occurrence of a short-circuit fault (abnormal condition)” as described above.

Suppose that a short-circuit fault occurs. In this case, the abnormality detecting portion 130 sends a signal indicative of this fact (occurrence of the short-circuit fault) to the integrated control device 100. As a result, the CPU makes an affirmative decision (“YES”) in step S220, and proceeds to step S510.

If the CPU proceeds to step S510, it sends the above-described “cut-off command signal” to the second switching device 54. As a result, the second switching device 54 switches from the “ON” state to the “OFF” state. Namely, the discharge current pathway of the rapid discharge circuit 50 is cut off, so that the voltage between the pair of high-voltage-side terminals P3, N3 is maintained. Accordingly, electric power can be kept supplied to the load unit 12 (the first motor 81, the second motor 82, etc.), so as to keep the vehicle 10 running. Thereafter, the CPU proceeds to step S595, to once finish the routine of FIG. 5.

As explained above, the second power-supply unit 11A includes the high-voltage source HVS that generates a high voltage between the positive electrode (terminal P3) and the negative electrode (terminal N3) so as to supply electric power to the load unit 12 connected to the positive electrode and the negative electrode, the smoothing capacitor 40 connected between the positive electrode and the negative electrode, the discharge portion DCHG (rapid discharge circuit 50) that is connected between the positive electrode and the negative electrode and includes the resistor (resistive element) 51 and the first switching device 52 connected in series with each other, and the discharge control portion (discharge control circuit) 120 that controls the first switching device 52 to any one of the “ON” state and the “OFF” state. In the power-supply unit 11A, when the first switching device 52 is in the “ON” state, an electric charge stored in the smoothing capacitor 40 is discharged by means of the rapid discharge circuit 50. Further, the rapid discharge circuit 50 includes the second switching device 54 connected in series with the resistor (discharge resistor) 51 and the first switching device 52. The power-supply unit 11A further includes a forcedly cutting-off portion (the integrated control device 100, step S210—step S510 of FIG. 5) that switches the second switching device 54 from the “ON” state to the “OFF” state, when an abnormal condition (an abnormal condition in which the first switching device 52 is placed in the “ON” state) in which electric current (current equal to or larger than a value corresponding to the threshold value for determining a short-circuit fault (abnormal condition)) flows through the resistor 51 is detected while the discharge control circuit 120 controls the first switching device 52 so as to keep the first switching device 52 in the “OFF” state.

Accordingly, when a short-circuit fault occurs to the rapid discharge circuit 50 of the vehicle 10, the second switching device 54 in the rapid discharge circuit 50 switches from the “ON” state to the “OFF” state, so that the discharge current pathway is forcedly cut off, and discharging is stopped. Accordingly, the second power-supply unit 11A is able to cut off the discharge current pathway instantly (within a response time of the second switching device 54), so as to accomplish the intended object.

The invention is not limited to the above-described embodiments, but various modified examples may be employed within the scope of the invention. For example, the vehicle 10 may be an electric vehicle. Also, the boost converter 30 may be a voltage converting device of a type other than that as illustrated above. In addition, the collision detecting portion 110 may be a known ECU and sensor for control of an air-bag system. Also, the rapid discharge control circuit 120 may directly receive a collision detection signal from the collision detecting portion 110, and switch the first switching device 52 from the “OFF” state to the “ON” state.

What is claimed is:

1. A power-supply unit comprising:
a high-voltage source configured to generate a high voltage between a positive electrode and a negative electrode so as to supply electric power to a load unit connected to the positive electrode and the negative electrode;
a smoothing capacitor connected to the positive electrode and the negative electrode;
a discharge portion that includes a resistor and a first switching device connected in series with each other, and is connected to the positive electrode and the negative electrode;
a discharge control portion configured to control the first switching device to one of an ON state and an OFF state;
an abnormality detecting portion configured to detect occurrence of an abnormal condition in which electric current flows through the resistor even though the discharge control portion controls the first switching device so as to keep the first switching device in the OFF state; and
a forcedly cutting-off portion configured to forcedly cut off a discharge current pathway formed by the discharge portion, when the abnormal condition is detected,
wherein the smoothing capacitor and the discharge portion are configured such that an electric charge of the smoothing capacitor is discharged by the discharge portion when the first switching device is in the ON state.

2. The power-supply unit according to claim 1, wherein
when the abnormal condition is detected, the forcedly cutting-off portion is configured to control the high-voltage source so that the high-voltage source keeps generating a given high voltage for fusing the resistor of the discharge portion.

3. The power-supply unit according to claim 1, wherein:
the discharge portion includes a second switching device connected in series with the resistor and the first switching device; and
the forcedly cutting-off portion is configured to switch the second switching device from an ON state to an OFF state when the abnormal condition is detected.
